(19) United States
(12) Patent Application Publication
(10) Pub. No.: US 2007/0213958 A1
(43) Pub. Date: Sep. 13, 2007

(54) Measuring arrangement with sensor having identification unit

(76) Inventors: Alexander Friedl, Graz (AT); Josef Glaser, Graz (AT); Klaus-Christoph Harms, Graz (AT); Klaus Leitmeier, Graz (AT); Josef Moik, Graz (AT); Rudiger Teichmann, Graz (AT); Wolfgang Wallnofer, Graz (AT)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 11/797,836

(22) Filed: May 8, 2007

Related U.S. Application Data
(62) Division of application No. 10/265,153, filed on Oct. 7, 2002.

(30) Foreign Application Priority Data
Oct. 8, 2001 (AT) GM 769/2001

(51) Int. Cl. G06F 15/00

(52) U.S. Cl. 702/189

(57) ABSTRACT

A measuring arrangement including a sensor (1), an interpretation unit (3) connected to said sensor via a detachable connection cable (2), and a memory module (4) having sensor-relevant data whereby the memory module is assigned to the sensor and may be interrogated by the interpretation unit to simplify deference of the sensor-relevant data in the interpretation unit (3) following a possible exchange of sensors. The memory module (4) is arranged outside of the sensor (1) so that the arrangement can also be employed in a rough environment whereby there is provided on the sensor (1) itself an identification unit (5) having a sensor identification ability that may be correlated with the memory module (4).

### BACKGROUND OF THE INVENTION

1. Field of the Invention

The invention relates to a measuring arrangement which includes a sensor, an interpretation unit connected to the sensor via a detachable connection cable, and a memory module having sensor-relevant data whereby the memory module is assigned to the sensor and may be interrogated by the interpretation unit.

2. The Prior Art

Measuring arrangements of this type are currently employed in many different ways and they allow, by means of sensors specifically tuned to the respective task, the detection and interpretation of a large range of measuring values to characterize mechanical, electrical, physical, and chemical quantities. Especially in conjunction with research and development tasks, the thereby used sensors are currently specialized and independent in such a manner that an accurate and individual adjustment (adaptation) of the connected interpretation unit to the respectively connected sensor is absolutely necessary to be able to achieve relevant measuring results at all.

There is a great number of sensor-relevant data that is absolutely to be considered in the correct taking of measurements, e.g. in conjunction with piezoelectric or piezo-resistive sensors, as they are used on a test bench for determination or monitoring of the pressure or temperature in the combustion chamber of internal combustion engines. For example, this sensor-relevant data includes measuring range, resonance characteristics, temperature drift, calibration data, or similar data, which individually characterize each sensor of this type and whereby the data may change during the course of the sensor's service life. This sensor-relevant data is acquired by the data sheets assigned to the respective sensors and the data may thereby be correspondingly considered in the use of the sensor or in its integration into the respective measuring arrangement, which has been performed to this date by the operator through manual input of the corresponding parameters into the interpretation unit in the above-mentioned use on test benches for internal combustion engines. This is naturally not only time-consuming but also prone to errors, which is especially of a disadvantage if numerous changes of employed sensors are necessary during the course of the measuring task, e.g., for consideration of altered measurement ranges.

In the last few years, similar problems were attempted to be solved in various areas whereby a memory module is inserted into the sensor in form of a microchip or a microcomputer in which the sensor-relevant data is stored in an interrogatable manner from the outside via the interpretation unit during connection or during operation of the sensor. See in this matter DE 39 02 767 A1 or U.S. Pat. No. 5,025,653 A, for example. Arrangements of this type allow in fact the relatively simple read-in and read-out of sensor-relevant data, depending on type and memory capacity of the memory module, but they have the disadvantage that the relatively high sensitivity of all known suitable memory modules limit the range of employment to a high degree. For example, arrangements of this type may be operated only at relatively low ambient temperatures (usually up to approximately 85°—and up to a maximum of approximately 250° with special arrangements); strong vibrations or jolting effects, or the like, are to be avoided. It follows then that the employment of such generally simple arrangements are very limited in their use and they are impossible for employment in the area of the test benches discussed already above, since temperatures of up to approximately 400° Celsius may occur on sensors for combustion chamber pressure together with additional strong vibration effects.

It is the object of the present invention to improve a measuring arrangement of the aforementioned type in such a manner that the above-mentioned disadvantages are avoided in reference to limited employment and that sensor-relevant data may be easily taken into consideration during the taking of measurements in a simple fashion.

### SUMMARY OF THE INVENTION

The present invention approaches the achievement of the object with the following ideas: Assuming the rough ambient conditions (high temperatures, high vibrations, and the like) existing under certain circumstances at the employment location (specifically relative to the discussed measuring tasks in conjunction with test benches for internal combustion engines), it would suggest itself immediately for those skilled in the art to shield the memory module provided in the sensor from ambient influences, according to the already discussed state-of-the-art for other measuring tasks, by means of thermal uncoupling, separate cooling, oscillation insulation and similar measures, which is in practice not a justifiable step mostly based on the limited availability of sufficient space and the limited manipulation ability of the sensors. As a next step, there remains thus the possibility to mount the memory module outside the sensor and thereby to place it outside the area of rough ambient influences, but which has again directly the disadvantage that the sensor, which is detachably connected by the connection cable, is then not reliable and it will always be a sensor that is characterized in the memory module by its sensor-relevant data. Under consideration of this thought, it is now proposed according to the present invention that the memory module is arranged outside the sensor whereby there is provided in or on the sensor itself an identification unit having sensor identification capability that can be correlated with the memory module. Thus, the essential basic functions of the memory module are in fact separated—the very few non-critical elements (relative to the rough ambient conditions) of the simple and storable identification data (e.g. a simple binary code) remain physically connected to the sensor in a firm manner, while the other sensor-relevant data (e.g. sensitivity curves, calibration data, and the like) are present in the separated memory module whereby only checking of the simple sensor identification is necessary for its appropriate association to ensure association of memory module and sensor.

In the simplest case, the identification unit on the sensor may be made simply by means of a printed label, a barcode strip or similar other optical means or by another suitable way of sensor identification that is readable by the operator, which has at least the advantage, compared to previously-known measuring arrangements, that the operator has to take care only of the actual association of memory module and sensor, whereby he has to input no longer the sensor-relevant data into the interpretation unit with all its error possibilities from the data sheets. In the scope of the invention, there are is certainly preferred the design of an identification unit in or on the sensor that is interrogatable for sensor identification from the memory module or the interpretation unit via the connection cable.

In the lastly mentioned context, it is proposed according to a preferred embodiment of the invention that in the design of the sensor as a piezoelectric measurement sensor, the identification unit of the sensor is formed by the piezoelectric element itself, which may be generated as an oscillation element via the connection cable by the memory module or the interpretation unit under exploitation of the inverse piezo effect, whereby the resonance spectrum of said oscillation element serves for sensor identification. Possibilities and concrete designs for such resonance excitement and resonance interpretation are disclosed, for example, in CH 657 457 A5, AT 387 286 B or also in AT 393 416 B. Of course, substantially preferred are here arrangements in which connection cables or measurement transmission wires, which are used usually for the normal measuring operation, may also find use at the same time for interrogation. of the sensor's identification unit. In a preferred way, the oscillation behavior of the sensor may be designed in an individual manner through constructive measures so that the sensor identification is more sharply separated. This may occur through the design of the measuring element or its environment itself or through the specific design of one or more additional oscillation elements.

According to another preferred embodiment of the invention, the identification unit of the sensor may be provided with at least one surface-acoustic-wave (SAW) element, which may be biased here with a high-frequency impulse via the connection cable from the memory module or the interpretation unit and which supplies, as a response, the signals serving for sensor identification. The excited wave on the surface of a piezoelectric material is influenced in such a manner by the attachment, the circuit, the impedance load of transducers or reflectors, so that information can be taken from the response by the elements to the high-frequency impulse, e.g., a simple identification code. An arrangement of this type is described in DE 44 05 647 A, for example, which is suitable for a one-time, repeat, interrogatable memory of a limited number of bits. Elements of this type work only passive whereby the high frequency (typically in the range of over 400 MHz) allows efficient inductive coupling without alternating effect on the measuring frequencies and resonance frequencies. Quartz, GaPO₄ or Langesit may be used, for example, as the piezoelectric substrate for the surface-acoustic-wave elements. In an especially preferred embodiment of the invention, a piezoelectric measuring element itself may serve directly as substrate for the surface-acoustic-wave element.

According to yet another preferred embodiment of the invention, the identification unit of the sensor may be provided with an oscillating element generating mechanical oscillations with varying resonance frequencies via the connection cable from the memory module or the interpretation unit whereby the pattern of resonance frequencies, which may be interrogated through a variation of excitation frequency, serves for sensor identification. There is therefore a mechanical oscillatable structure within the sensor having a specific number of electrically excitable elements, e.g., a comb-like structure made of piezo-crystal/ceramic, whereby each individual oscillatable tooth may have either one or several resonance frequencies. Of course, the natural (characteristic) frequency of these elements lie preferably in a range that is not necessary for measuring or which will not be distorted or influenced by the other sensor structure. The excitable oscillation elements show a clear excessive resonance increase during excitation with their natural frequency, which may be recognized as a pattern for sensor identification by the interpretation unit. This realization of the identification unit in the sensor is usable and uninfluenced without any problems and it makes possible thereby the necessary definite association of the sensor and the separated memory module.

In another development of the invention, the identification unit may be provided by at least one passive electric component, preferably at least one electric resistor of known magnitude, whose interrogatable value serves for sensor identification via the connection cable from the memory module or the interpretation unit. Passive electric components, e.g., the above-mentioned resistors or capacitors, inductors, waveguide elements, or complex bended impedances can even take higher temperatures or other negative ambient influences without problems, and they make possible at least a simple sensor identification as it is sufficient for many purposes.

In an especially preferred embodiment of the invention, the memory module itself may be arranged in the area of the connection cable and its connector plugs, which make possible easy manipulation of the inventive measuring arrangement or simple exchange of its components. Besides, there is naturally conceivable within the scope of the invention, for example, an arrangement of the memory module as a separate module inside or connected to the interpretation unit, which is then not changed together with the respective sensor and which contains thereby the sensor-relevant data for all possible sensors, and which would have to be possibly actualized by a new input of data from newly added sensors.

In a preferred additional embodiment of the invention the memory module is integrated into the connection cable between the two-sided connector plugs, which guarantees easy manipulation and which ensures in a simple manner the association of the two components based on the described correlation of sensor identification and the respective memory module.

In another especially preferred embodiment of the invention, the memory module is integrated into the side of the interpretation unit, which is constructively easily possible and which makes manipulation simple.

In the lastly mentioned context, it is further preferred that the connector plug at the side of the interpretation unit consists of a cable plug fixed to the connection cable and an adapter plug, which may be detached at both ends and which is disposed between the cable plug and the connecting socket on the interpretation unit whereby the memory module is arranged inside the adapter plug. Thus, the essential functions of the connector plug are divided in the scope of the present invention and a simpler spatial or constructive optimization of the individual components is thereby possible.

In the following, the invention is described in more detail with the aid of the embodiment examples that are schematically illustrated in the drawings.

### BRIEF DESCRIPTION OF THE DRAWINGS

FIG. 1 through FIG. 4 show various preferred embodiments of measuring arrangements according to preferred embodiments of the invention.

### DETAILED DESCRIPTION OF THE PREFERRED EMBODIMENTS

A sensor 1 is connected to an interpretation unit 3 via a detachable connection cable 2 according to all embodiment examples.

The sensor 1 is mounted at the measuring location in a not further illustrated manner and it supplies via the connection cable 2 continuous or non-continuous, interrogated or stand-alone electric signals to the interpretation unit 3 whereby the signals are correspondingly prepared and converted to measuring values representing the respective measured quantity. For example, the sensor 1 may be designed as a piezoelectric, pressure-sensing or force-sensing element and it may be employed in a not further illustrated combustion engine for measuring or monitoring the combustion chamber pressure.

For the purpose of identifying the sensor 1 with sensor-relevant data compared to the interpretation unit 3 (e.g., relative to the sensor sensitivity or the like) and to make thus unnecessary manual input of corresponding values from data sheets by the operator, there is provided a memory module 4 with sensor-relevant data assigned to the sensor 1 whereby the memory module 4 may be in form of a microchip or a microcomputer containing the corresponding data for read-in or read-out. The memory module is arranged outside of the sensor 1 in all embodiment examples whereby the memory module is un-coupled and away from detrimental effects of rough ambient conditions in the sensor region (e.g., high temperatures or strong vibrations). However, there is provided on the sensor 1 an identification unit 5 having a sensor identification capability that may be correlated with the memory module 4 to be able to guarantee the required correlation with the respective sensor.

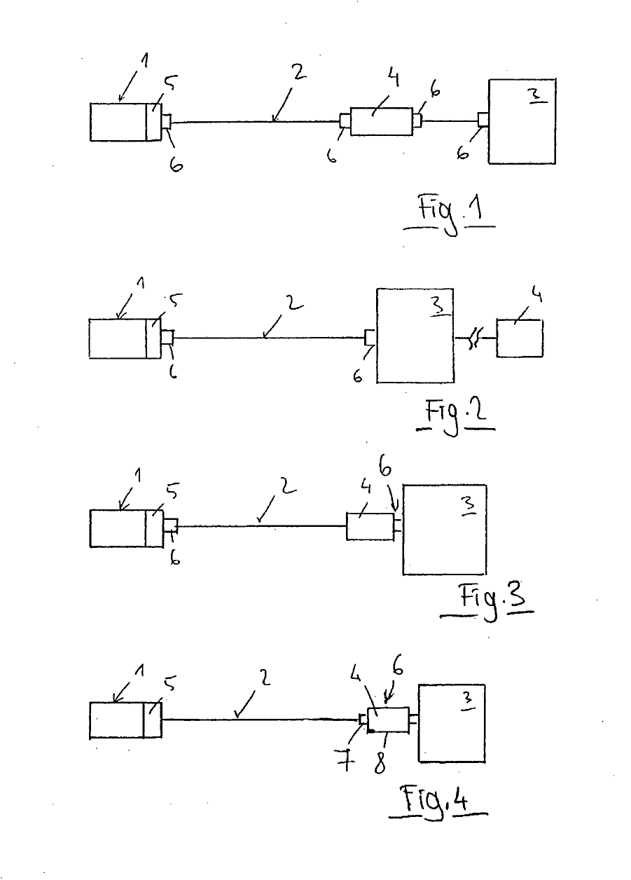

According to FIG. 1, the memory unit 4 is integrated into the connection cable 2 between the connector plugs 6 at the side of the sensor 1, on one hand, and to the side of the interpretation unit 3, on the other hand—however, it is of no importance whether there are yet additional connector plugs 6 provided on the memory module 4 itself, as illustrated, or whether the connection cable 2 is fixedly attached to the memory module 4. The connector plug 6 at the side of the sensor could furthermore be replaced by a fixed cable connection whereby there would remain altogether only one detachable plug-in connection for the memory module 4 and the connection cable 2 on the sensor 1.

According to FIG. 2, the sensor 1 is directly plugged into the interpretation unit 3 by means of a connection cable 2 (here again by means of two-sided connector plugs 6). The memory module 4 is hereby provided with a separated data base being in communication with the interpretation unit 3, which nevertheless simplifies the respective actual local tying-in of the sensor 1, but it is done under the condition that there is data stored in the memory module 4 or the corresponding data base pertaining to all possibly existing sensors 1. Apart from a direct line-type connection between the interpretation unit 3 and the memory module 4—or the corresponding data base—there could be provided here a data link that may be activated only as needed, for example, whereby the memory module 4 could be realized by a data base located away from the interpretation unit 3 and located centrally for several or all interpretation units 3. Interrogation of relevant sensor data would thereby only occur as needed, e.g., via a network connection.

According to FIG. 3, the memory module 4 is integrated into the connector plug 6 at the side of the interpretation unit 3 whereby a fixed connection of the connection cable 2 to the sensor 1 could be provided here also on the side of the sensor.

In the embodiment according to FIG. 4, the connector plug 6 on the side of the interpretation unit 3 consists of a cable plug 7 fixed to the connection cable 2 and of an adapter plug 8 detachable at two ends that is disposed between the cable plug 7 and the connecting socket on the interpretation unit 3 whereas the memory module 4 is arranged inside the adapter plug 8.

It is a common feature in all illustrated embodiment examples that the memory module 4 communicates with the identification unit 5 of the sensor 1 via the measurement transmission wire of the sensor in the connection cable 2 whereby additional connections between the above-mentioned components are unnecessary. A connection of the memory module 4 to the interpretation unit 3 may be established also via several [transmission] wires, as needed.

The identification unit 5 of the sensor 1 may be formed, for example, by a piezoelectric measuring element inside the sensor 1 itself in the manner described above (not further illustrated), which may be generated via the connection cable as an oscillation element through utilization of the inverse piezo effect whereby the resonance spectrum of the oscillation element serves for sensor identification. In addition, a surface-acoustic-wave element could be provided in the identification unit 5 whose response to an excited high-frequency impulse serves as sensor identification. Additional possibilities of the exact design of the identification unit 5 are described in the beginning.

1.-11. (canceled)

12. A measuring apparatus comprising:
a sensor for detecting mechanical, electrical, physical or chemical values and emitting measurement signals,
an identification unit in or on said sensor and having a sensor identification capability,
an interpretation unit for converting measurement signals from said sensor into measurement values,
a memory module containing data relevant to said sensor,
a first connection cable having first and second ends, said first end being connected to said sensor and said second end being connected to said memory module, and
a second connection cable having first and second ends, said first end being connected to said memory module and said second end being connected to said interpretation unit.

13. A measuring apparatus according to claim 12, wherein said first connection cable includes a plug at said first end thereof which is detachably connected to said sensor.

14. A measuring apparatus according to claim 12, wherein said first connection cable includes a plug at a second end thereof which is detachably connected to said memory module.

15. A measuring apparatus according to claim 12, wherein said first connection cable includes respective plugs at said first and second ends thereof which are respectively detachably connected to said sensor and to said memory module.

16. A measuring apparatus according to claim 12, wherein said second connection cable includes a plug at said first end thereof which is detachably connected to said memory module.

17. A measuring apparatus according to claim 12, wherein said second connection cable includes a plug at said second end thereof which is detachably connected to said interpretation unit.

18. A measuring apparatus according to claim 12, wherein said second connection cable includes respective plugs at said first and second ends thereof which are respectively detachably connected to said memory module and said interpretation unit.

19. A measuring apparatus according to claim 12, wherein said sensor is a piezoelectric measurement sensor.

20. A measuring apparatus according to claim 12, wherein said identification unit includes a surface-acoustic-wave element.

21. A measuring apparatus comprising:
a sensor for detecting mechanical, electrical, physical or chemical values and emitting measurement signals,
an identification unit in or on said sensor and having a sensor identification capability,
an interpretation unit for converting measurement signals from said sensor into measurement values,
a first connection cable having first and second ends, at least one of said first and second ends including a plug which is detachably connected to said sensor and/or said interpretation unit,
a memory module containing data relevant to said sensor, and
a second connection cable having a first end connected to said interpretation unit and a second end connected to said memory module.

22. A measuring apparatus according to claim 21, wherein said sensor is a piezoelectric measurement sensor.

23. A measuring apparatus according to claim 21, wherein said identification unit includes a surface-acoustic-wave element.

24. A measuring apparatus comprising:
a sensor for detecting mechanical, electrical, physical or chemical values and emitting measurement signals,
an identification unit in or on said sensor and having a sensor identification capability,
an interpretation unit for converting measurement signals from said sensor into measurement values,
a memory module containing data relevant to said sensor,
a connection cable having first and second ends, said first end including a plug which is detachably connected to said sensor and said second end being fixedly connected to said memory module, and
said memory module including a second plug detachably connected to said interpretation unit.

25. A measuring apparatus according to claim 24, wherein said sensor is a piezoelectric measurement sensor.

26. A measuring apparatus according to claim 24, wherein said identification unit includes a surface-acoustic-wave element.

27. A measuring apparatus comprising:
a sensor for detecting mechanical, electrical, physical or chemical values and emitting measurement signals,
an identification unit in or on said sensor and having a sensor identification capability,
an interpretation unit for converting measurement signals from said sensor into measurement values,
an adaptor plug containing a memory module containing data relevant to said sensor, said adaptor plug being detachably connected to said interpretation unit, and
a connection cable having first and second ends, said first end being connected to said sensor and said second end including a cable plug which is detachably connected to said adaptor plug.

28. A measuring apparatus according to claim 27, wherein said sensor is a piezoelectric measurement sensor.

29. A measuring apparatus according to claim 27, wherein said identification unit includes a surface-acoustic-wave element.
